(19) United States
(12) Patent Application Publication
(10) Pub. No.: US 2014/0205408 A1
(43) Pub. Date: Jul. 24, 2014

(54) CARGO DEPLOYMENT SYSTEM

(71) Applicant: GM GLOBAL TECHNOLOGY OPERATIONS LLC, Detroit, MI (US)

(72) Inventor: Chet R. Wisniewski, Royal Oak, MI (US)

(73) Assignee: GM Global Technology Operations LLC, Detroit, MI (US)

(21) Appl. No.: 13/746,586

(22) Filed: Jan. 22, 2013

(51) Int. Cl. B60P 1/43

(52) U.S. Cl. CPC B60P 1/433
USPC 414/522; 414/813

(57) ABSTRACT

Select variation may include a cargo deployment system which may include at least one module for containment and delivery of cargo to a location, which may also include a vehicle for thoroughfare delivery of the module which may also include an edge at or within the height of a curb on a thoroughfare for deployment of the module onto the curb.

### TECHNICAL FIELD

The field to which the disclosure generally relates to includes systems, methods, and products used to deploy and deliver cargo in carrier vehicles.

### BACKGROUND

A cargo deployment system may have a plurality of modules to deploy a cargo from a first location to a second location for delivery. The cargo may be deployed via a vehicle to move the cargo from a first location to a second location with increased speed. The cargo may be deployed from the vehicle at thoroughfare locations in congested cities.

### SUMMARY OF ILLUSTRATIVE VARIATIONS OF THE INVENTION

One variation may include a system for deployment of cargo which may include at least one module for containment and delivery of cargo to a location and a vehicle for thoroughfare delivery of the module. The vehicle may further include an edge at or within 2 inches of the height of a curb on a thoroughfare for deployment of the module onto the curb.

Another variation may include a product which may include a cargo delivery system which may include a vehicle wherein the vehicle may include an edge at or within 2 inches of the height of a curb on a thoroughfare.

Another variation may include method which may include loading at least one module for delivery to the location into a vehicle through an edge on the side of a vehicle that is at or within 2 inches of the height of a curb on a thoroughfare; moving the vehicle closer to the location; un-loading the module from the vehicle through the edge on the side of the vehicle that is at or within 2 inches of the height of a curb on a thoroughfare; and delivering the module to the location.

Other illustrative variations of the invention will become apparent from the detailed description provided hereinafter. It should be understood that the detailed description and specific examples, while disclosing optional variations of the invention, are intended for purposes of illustration only and are not intended to limit the scope of the invention.

### BRIEF DESCRIPTION OF THE DRAWINGS

Select examples of variations of the invention will become more fully understood from the detailed description and the accompanying drawings, wherein:

FIG. 1 is a perspective view of one variation of a cargo deployment system.

FIG. 2 is an enlarged longitudinal view of a vehicle, showing one variation of a product.

FIG. 3 is an enlarged side view of a vehicle, showing one variation of a product.

### DETAILED DESCRIPTION OF ILLUSTRATIVE VARIATIONS OF THE INVENTION

The following description of the variations is merely illustrative in nature and is in no way intended to limit the invention, its application, or uses.

The figures illustrate a number of variations of a cargo deployment system 10, which may ease existing issues of traffic congestion, parking (and associated penalties), weight, mobility, speed, and integration within a densely populated urban area. The cargo deployment system 10, may be used to deliver a variety of cargo types including, but not limited to, mail, emergency supplies, munitions, goods, produce, bulk cargo, project cargo, or may be another type. The cargo deployment system 10 may also, among other things, be updated, implemented, or modified to support/suspend cargo and protect it from the elements through the use of a vehicle 12, module 14, and edge 16. Although the cargo deployment system 10 is shown and described with a vehicle 12, module 14, and edge 16, the cargo deployment system 10 may have other configurations and arrangements including, but not limited to, a platform 18, that abuts the edge 16 and the curb 20. The edge 16 may partially define a cargo doorway of the vehicle for loading and unloading the modules 14.

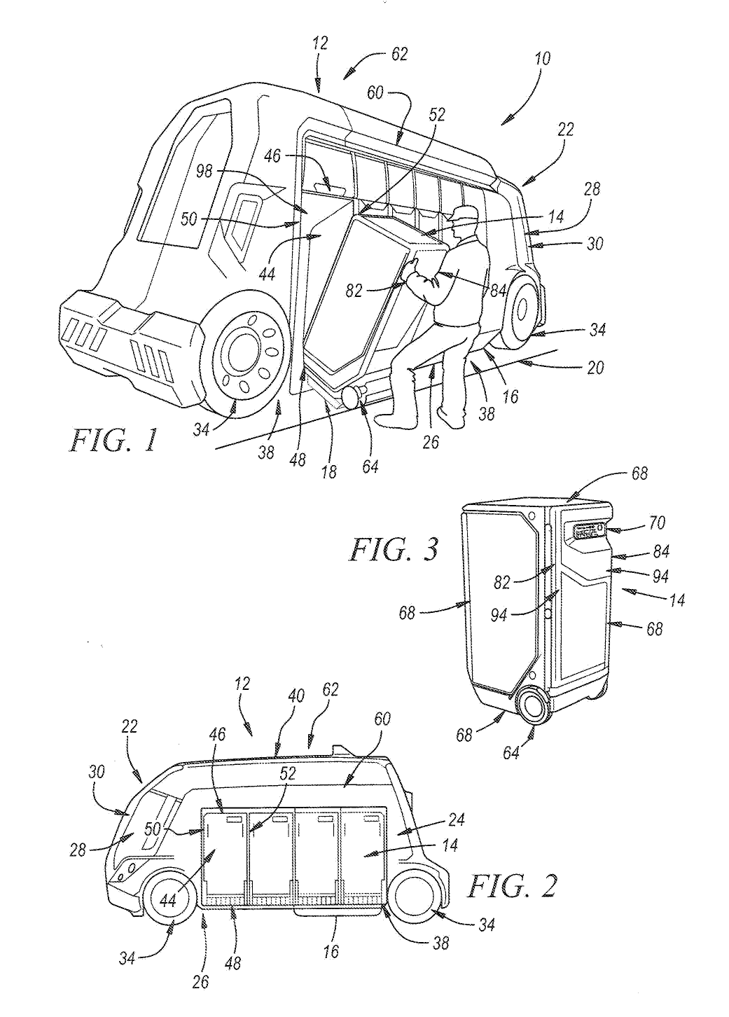

Referring to FIGS. 1-2, select variations of the cargo deployment system 10 may include a vehicle 12, and a module 14. The vehicle 12 may include a means of locomotion including vehicles such as, but not limited to, cars, buses, trains, planes, boats, or may be a different type. The vehicle may include locomotion means 34, which may include wheels or may move by another means. The vehicle 12 may include a cab 22, and a carrier 24 supported by chassis 26. It is to be understood that the suspension, brakes, fuel system, and other usual vehicle devices, mechanisms, and accessories, though not shown, may be included as required in the conventional state of the art in vehicle assembly. The cab 22 may be metallic with a rounded front 28 including a windshield 30 made of safety glass with rounded ends which extends traversely across the cab 22. A driver may operate the vehicle 12 from a driver's seat (not shown). Beneath the vehicle lies an engine (not shown) to power the vehicle 12 along its locomotion means 34. Coaxial with and adjoining the cab 22, the vehicle 12 may have a carrier 24 for transporting modules 14. The carrier may be made of sheet metal construction or may be polymeric material or another similarly functioning material. The carrier 24 may have two opposing longitudinal sides 60, 62 for transporting the modules. The carrier 24 may have a floor 38 which connects the two longitudinal sides 60, 62 as well as a roof 40 of the carrier 24. The carrier 24 may have a plurality of pods 44 extending across the length of the carrier 24 in the longitudinal direction parallel to a thoroughfare. These pods 44 may be used for transporting and housing modules 14. The pods 44 may have a top 46, a bottom 48, a first side 50, and a second side 52. The pods may ingress into the carrier 24 of the vehicle 12. The pod bottom 48 serves as a measuring point for the height of a curb on the thoroughfare that the vehicle 12 uses. The pod bottom 48 may be the height of the curb of the thoroughfare within 2 inches or less to ease ingress and egress of the modules into the pods 44 in the carrier 24. Along the longitudinal length of the vehicle 12, the pod bottoms 48 may form an edge 16, which may be within 2 inches of the height of the curb 20 on the thoroughfare. In one variation the edge 16 may be located at a distance ranging from 4-8 inches from a lower resting surface where the thoroughfare contacts the vehicle 12 or locomotion means 34, which may include a wheel, or 4-8 inches from the ground or thoroughfare on which the vehicle rests. In a number of variations the edge 16 may not be movable and may be fixed relative to the vehicle, for example, fixed with respect to the chassis 26 or carrier 24. In other variables the edge 16 may be movable. The vehicle may also include a platform 18 that can be moved manually or automatically via the vehicle 12 power system to provide a surface between the edge 16 and the curb 20. The vehicle 12 or module 14 may include a display panel 70. The display panel 70 may display information. The information may include cargo tracking information, destination area, zip code, or cargo recipient address or a bar code or other code having such information which may be read and translated by an electronic code reader. The information may be preloaded onto the display panel 70 manually or electronically. The vehicle 12 may have an attachment 98 to attach the module 14 to the vehicle 12 in the pod 44. The attachment 98 may be may be a clip, tongue and groove, screw, nail, joint, or may be another type. The attachment 98 may be made of a polymeric material, fibrous material, textile material or metallic material and/or other similarly functioning materials.

Referring to FIG. 3, the module 14 may be any shape and also may include wheels 64 or may move by another means. In one variation a pair of wheels 64 may be provided near one side 68 of the module 14 and in another variation may be provided near opposite sides 68 of the module 14. The module 14 may be used for storing cargo. The module 14 may be made of polymeric material or metallic material and/or other similarly functioning materials. The module 14 may have a plurality of sides 68. The module 14 may include a display panel 70. The display panel 70 may display information. The information may include cargo tracking information, destination area, zip code, or cargo recipient address or a bar code or other code having such information which may be read and translated by an electronic code reader. The information may be preloaded onto the display panel 70 manually or electronically. The module may have side handles 82, 84 for grasping and moving the module manually. The module 14 may also move via an electronic remote control system for delivery. The module 14 may include a side 68 that opens and closes for insertion or withdrawal of the cargo. The module 14 may have an attachment 94 to attach the module 14 to the vehicle 12 in the pod 44. The attachment 94 may be may be a clip, tongue and groove, screw, nail, joint, or may be another type. The attachment 94 may be made of a polymeric material, fibrous material, textile material or metallic material and/or other similarly functioning materials.

In another variation a method is introduced which includes loading a module 14 for delivery to a location into a vehicle 12 through an edge 16 on the side of a vehicle 12 that may be at or within 2 inches of the height of a curb on a thoroughfare. The method may further include moving the module 14 into a pod 44 of the vehicle 12 by moving the module 14 from the curb of a thoroughfare into the vehicle pod 44 via the module wheel 64 or through another means of locomotion. The module 14 may be moved into the pod via manual grasping of the side handles 82, 84. The module 14 may then be held in place in the pod 44 within the vehicle 12 via the attachment on the vehicle 98 or the attachment on the module 94 or both. A platform 18 may aid in moving the module 14 from the curb on the thoroughfare into the vehicle pod 44 of the vehicle 12. The loading of the module 12 may be done manually or through electronic or mechanical means. The vehicle 12 and module 14 may then move closer to the location via locomotion of the vehicle 12. The module may then be un-loaded for delivery to a location out of a vehicle 12 from the vehicle pod 44 through an edge 16 on the side of a vehicle 12 that may be at or within 2 inches of the height of a curb on a thoroughfare. The module 14 may then be unloaded from the vehicle pod 44 by un-attaching the module from the vehicle 12 and more specifically the vehicle pod 44 by undoing the attachment on the vehicle 98 or the attachment on the module 94 or both. The method may further include un-loading the module 14 from a pod 44 of the vehicle 12 by moving the module 14 from the vehicle pod 44 onto the curb of a thoroughfare via the module wheel 64 or through another means of locomotion. The module 14 may be moved from the pod via manual grasping of the side handles 82, 84. The un-loading of the module 12 may be done manually or through electronic or mechanical means. A platform 18 may aid in moving the module 14 from the vehicle pod 44 of the vehicle 12 to the curb on the thoroughfare. The module 14 with its cargo may then be delivered to the location.

The vehicle 12 or module 14 may include a display panel 70. The display panel 70 may display information. The information may include cargo tracking information, destination area, zip code, or cargo recipient address or a bar code or other code having such information which may be read and translated by an electronic code reader. The information may be preloaded onto the display panel 70 manually or electronically. The cargo may be presorted into the module 14 according to the location that may be its final destination via the information on the display panel. The display panel 70 may set a pre-determined location for the cargo inside the module 14 to go. The vehicle 12 may follow a route 100 for delivery of the cargo inside the module 14. The route 100 may be pre-determined along a thoroughfare. The vehicle 12 may stop along the route 100 for delivery of the module 14 that contains the cargo to the location the cargo may be meant for delivery to. There may be a plurality of modules 14 meant for a plurality of different locations. The locations may be bunched along the route so that at a thoroughfare, the modules 14 may be loaded and un-loaded manually, electronically, or mechanically at a plurality of unloading points 102 that would increase the efficiency of the delivery of the cargo inside the module to its location. The display panel may indicate which modules 14 are meant to be unloaded at which unloading points 102. The indication may be done visually or audibly or may be another type. The use of unloading points 102 along pre-determined routes 100 may increase efficiency by allowed the driver of the vehicle 12 to stay in the vehicle 12 during loading and unloading of the modules 14. This may increase efficiency of deployment of the cargo to its location.

The following description of variants is only illustrative of components, elements, acts, product and methods considered to be within the scope of the invention and are not in any way intended to limit such scope by what is specifically disclosed or not expressly set forth. The components, elements, acts, product and methods as described herein may be combined and rearranged other than as expressly described herein and still are considered to be within the scope of the invention.

Variation 1 may include a system for deployment of cargo including at least one module for containment and delivery of cargo to a location and a vehicle for thoroughfare delivery of the module further including an edge at or within 2 inches of the height of a curb on a thoroughfare for deployment of the module onto the curb.

Variation 2 may include a system as set forth in Variation 1 further including a display panel displaying information on the location wherein the information includes at least one of cargo tracking information, destination area, zip code, or cargo recipient address or a bar code or other code having such information which may be read and translated by an electronic code reader.

Variation 3 may include a system as set forth in any of Variations 1-2 wherein the module has at least one wheel.

Variation 4 may include a system as set forth in Variation 2 wherein the display panel may be located on the module.

Variation 5 may include a system as set forth in any of Variations 1-4 wherein the module or edge may be located on a longitudinal side of the vehicle.

Variation 6 may include a system as set forth in any of Variations 1-5 wherein the wherein the location may be pre-determined. Variation 6 may include a system as set forth in any of Variations 1-5 wherein the wherein the location may be pre-determined.

Variation 7 may include a system as set forth in any of Variations 1-6 wherein the wherein the cargo may be presorted to arrive at the location on the display panel.

Variation 8 may include a system as set forth in any of Variations 1-7 wherein the vehicle further comprises an adjustable panel that moves between the vehicle edge and curb.

Variation 9 may include a product including a cargo delivery system including a vehicle wherein the vehicle includes an edge at or within 2 inches of the height of a curb on a thoroughfare.

Variation 10 may include a product as set forth in Variations 9 further including a module wherein the module has at least one wheel.

Variation 11 may include a product as set forth in any of Variations 9-10 further including a display panel displaying information on the location wherein the information includes at least one of cargo tracking information, destination area, zip code, or cargo recipient address or a bar code or other code having such information which may be read and translated by an electronic code reader.

Variation 12 may include a product as set forth in any of Variations 9-11 wherein the display panel may be located on the module.

Variation 13 may include a product as set forth in any of Variations 9-12 wherein the module or edge may be located on a longitudinal side of the vehicle.

Variation 14 may include a product as set forth in any of Variations 9-13 wherein the vehicle further comprises an adjustable panel that moves between the vehicle edge and curb.

Variation 15 may include a product as set forth in any of Variations 9-14 wherein the cargo may be presorted to arrive at the location on the module.

Variation 16 may include a method including loading at least one module for delivery to a location into a vehicle through an edge on the side of a vehicle that may be at or within 2 inches of the height of a curb on a thoroughfare, moving the vehicle closer to the location, un-loading the module from the vehicle through the edge on the side of the vehicle that may be at or within 2 inches of the height of a curb on a thoroughfare, and delivery the module to the location.

Variation 17 may include a method as set forth in Variation 16 including providing a display panel displaying information on the location wherein the information includes at least one of cargo tracking information, destination area, zip code, or cargo recipient address or a bar code or other code having such information which may be read and translated by an electronic code reader.

Variation 18 may include a method as set forth in any of Variations 16-17 including loading or unloading the module along a pre-determined route.

Variation 19 may include a method as set forth in any of Variations 16-18 wherein the un-loading and loading of the module may be done manually, mechanically, or electronically.

Variation 20 may include a method as set forth in any of Variations 16-19 wherein the display panel indicates where the module may be loaded or unloaded along the predetermined route.

Variation 21 may include a product as set forth in any of Variations 9-15 wherein the vehicle has at least one pod that ingresses into the vehicle.

Variation 22 may include a product as set forth in any of Variations 9-15 and 21 wherein the vehicle or the module has an attachment to attach the module to the vehicle.

Variation 23 may include a product as set forth in any of Variations 11-15 and 21-22 wherein the information may be preloaded into the display panel.

Variation 24 may include a product as set forth in any of Variations 16-19 wherein module may be delivered via a remote control system.

Variation 25 may include a method as set forth in any of Variations 17-20 wherein display panel indicates audibly or visually when a module should be unloaded from the vehicle for delivery of the cargo.

Variation 26 may include a product as set forth in any of Variations 9-15 and 21-25 wherein the edge may be within 3 inches of the height of the curb on the thoroughfare.

Variation 27 may include a system as set forth in any of Variations 1-8 wherein the edge may be within 3 inches of the height of the curb on the thoroughfare.

Variation 28 may include a method as set forth in any of Variations 16-20 and 25 wherein the edge may be within 3 inches of the height of the curb on the thoroughfare.

The above description of select examples of the invention is merely exemplary in nature and, thus, variations or variants thereof are not to be regarded as a departure from the spirit and scope of the invention.

What is claimed is:

1. A system for deployment of cargo comprising:
at least one module for containment and delivery of cargo to a location;
a vehicle for thoroughfare delivery of the module further comprising an edge at or within 2 inches of the height of a curb on a thoroughfare for deployment of the module onto the curb.

2. The system of claim 1 further comprising a display panel displaying information on the location wherein the information includes at least one of cargo tracking information, destination area, zip code, cargo recipient address, or a bar code or other code having such information which may be read and translated by an electronic code reader.

3. The system of claim 1 wherein the module has at least one wheel.

4. The system of claim 2 wherein the display panel is located on the module.

5. The system of claim 1 wherein the module or edge is located on a longitudinal side of the vehicle.

6. The system of claim 1 wherein the location is pre-determined.

7. The system of claim 2 wherein the cargo is presorted to arrive at the location on the display panel.

8. The system of claim 1 wherein the vehicle further comprises an adjustable platform that moves between the vehicle edge and curb.

9. A product comprising:
a cargo delivery system comprising a vehicle wherein the vehicle comprises an edge at or within 2 inches of the height of a curb on a thoroughfare.

10. The product of claim 9 further comprising a module wherein the module has at least one wheel.

11. The product of claim 9 further comprising a display panel displaying information on the location wherein the information includes at least one of cargo tracking information, destination area, zip code, cargo recipient address, or a bar code or other code having such information which may be read and translated by an electronic code reader.

12. The product of claim 10 wherein the display panel is located on the module.

13. The product of claim 9 wherein the module or edge is located on a longitudinal side of the vehicle.

14. The product of claim 9 wherein the vehicle further comprises an adjustable panel that moves between the vehicle edge and curb.

15. The product of claim 9 wherein the cargo is presorted to arrive at the location on the module.

16. A method comprising:
loading at least one module for delivery to a location into a vehicle through an edge on the side of a vehicle that is at or within 2 inches of the height of a curb on a thoroughfare;
moving the vehicle closer to the location;
un-loading the module from the vehicle through the edge on the side of the vehicle that is at or within 2 inches of the height of a curb on a thoroughfare; and
delivering the module to the location.

17. The method of claim 16 further comprising providing a display pan& displaying information on the location wherein the information includes at least one of cargo tracking information, destination area, zip code, cargo recipient address, or a bar code or other code having such information which may be read and translated by an electronic code reader.

18. The method of claim 16 further comprising loading or unloading the module along a pre-determined route.

19. The method of claim 16 wherein the un-loading and loading of the module is done manually, mechanically, or electronically.

20. The method of claim 16 wherein the display panel indicates where the module is to be loaded or unloaded along the predetermined route.
